(19) United States
(12) Patent Application Publication
(10) Pub. No.: US 2013/0145186 A1
(43) Pub. Date: Jun. 6, 2013

(54) UNIVERSAL SERIAL BUS DEVICE CAPABLE OF REMOTE WAKE-UP THROUGH A SPECIAL MASK CIRCUIT

(71) Applicants: Chun-Chi CHU, Hsinchu (TW); Che-Wei Chang, Hsinchu (TW); Kuang Ming Tseng, Hsinchu (TW); Wei-Lu Su, Hsinchu (TW)

(72) Inventors: Chun-Chi CHU, Hsinchu (TW); Che-Wei Chang, Hsinchu (TW); Kuang Ming Tseng, Hsinchu (TW); Wei-Lu Su, Hsinchu (TW)

(21) Appl. No.: 13/366,037

(22) Filed: Feb. 3, 2012

(30) Foreign Application Priority Data
Dec. 5, 2011 (TW) 100144571

(51) Int. Cl. G06F 1/00

(52) U.S. Cl. 713/310

(57) ABSTRACT

The present invention discloses a Universal Serial Bus (“USB”) device capable of remote wake-up through a special mask circuit. The USB device includes an Ethernet port to transmit a first signal in response to a predetermined network packet, a wake-up pin to transmit a second signal in response to a remote wake-up trigger signal, a remote wake-up circuit to generate a wake-up signal in response to either the first signal or the second signal, and a mask circuit to receive the wake-up signal and delay transmission of the wake-up signal to a remote USB host for a predetermined delay time.

### BACKGROUND OF THE INVENTION

1. Technical Field

The present invention relates to a Universal Serial Bus device capable of remote wakeup, and more particularly, to a Universal Serial Bus device capable of remote wakeup through a special mask circuit.

2. Background

With current Universal Serial Bus (“USB”) technology, there are two types of wakeup methods. The first type of wakeup method is known as host resume, which is usually performed by a computer to wake up all system devices, including a USB device, so there is no problem with compatibility among devices. The second type of wakeup method is the device remote-wakeup method, which is usually executed by a USB to wake up a USB host. The device remote-wakeup method may suffer from compatibility issues and un-wakeup host problems.

FIG. 1 shows a block diagram of a USB device 12 in prior art. The USB device 12 includes a USB port 111 that connects via a USB transmission line 14 to a USB port 112 of a USB host 10; a wakeup pin 18 to transmit a trigger signal to wake up the USB device 12; an Ethernet port 15 to receive specific network packets, such as Magic Packets and Wakeup Frames, from an external twist line 13 to wake up the USB device 12; and a remote wakeup circuit 16 to generate a wakeup signal to wake up the USB host 10 via the USB ports 111 and 112.

Referring to FIG. 1, when a USB device 12 is plugged into a USB host 10, a signal is sent to the USB host 10 to indicate whether the USB device 12 supports the remote wakeup function, and a Set_Feature command is used to enable and activate the remote wakeup function of the USB device 12. The USB host 10 sets the USB device 12 into a suspend mode through the USB ports 111, 112. Next, the remote wakeup circuit 16 receives a specific packet from the Ethernet port 15 or an external switch trigger signal to wake up the USB device 12, and then a signal is sent through the USB port 111 to wake up the USB host 10. The USB host 10 then sends a Clear_Feature command to disable the remote wakeup function. The USB host 10 requires several seconds or several tens of seconds to enter the suspend mode. Because the USB device 12 is unable to know when the USB host 10 enters the suspend mode, and the USB host 10 does not specify the minimal remote wakeup time, the USB host 10 and the USB device 12 may operate in different modes, so the USB host 10 may have a compatibility issue and may not wake up.

### SUMMARY

The present invention discloses a USB device with remote wakeup function. A USB device with remote wakeup function according to one embodiment of the present invention comprises an Ethernet port, which transmits a first signal in response to a specific network packet, a wakeup pin, which transmits a second signal in response to a trigger signal, a remote wakeup circuit, which generates a wakeup signal in response to the first signal or the second signal, and a wakeup mask circuit, which is configured to receive the wakeup signal and, within a specific time interval, disable the wakeup signal transmission to a USB host.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1 shows a block diagram of a USB device in prior art;

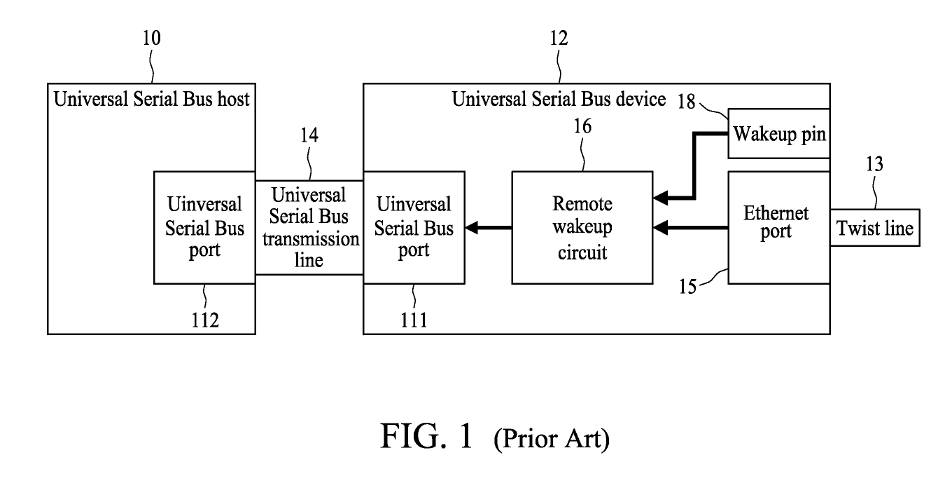

FIG. 2 shows a block diagram of a USB device including a wakeup mask circuit according to one embodiment of the present invention; and

FIG. 3 shows the block diagram of the wakeup mask circuit in FIG. 2 according to one embodiment of the present invention.

### DETAILED DESCRIPTION

The embodiments of the present invention are shown in the following description with the drawings, wherein similar or same components are indicated by similar reference numbers.

The present invention relates to a USB device with remote wakeup function. A specific network packet, which may include but is not limited to a remote wakeup packet of Wake-on-LAN, Magic Packet and Wake-up Frame, or an external hardware trigger, may be sent to wake up the device and through a USB port to wake up a USB host.

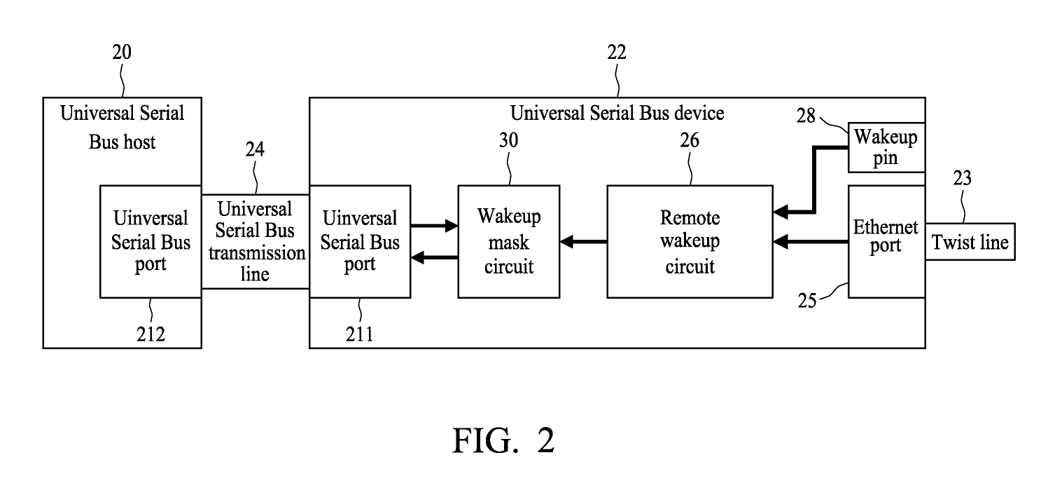

FIG. 2 shows a block diagram of a USB device 22 according to one embodiment of the present invention. Referring to FIG. 2, the USB device 22 includes a USB port 211, a wakeup pin 28, an Ethernet port 25, a remote wakeup circuit 26 and a wakeup mask circuit 30.

As shown in FIG. 2, the USB device 22 connects through the USB port 211 and a USB transmission line 24 to a USB port 212 of a USB host 20 in order to wake up the USB host 20.

The wakeup pin 28 connects to an external pin of the USB device 22 to receive an external driving signal, such as a remote wakeup driving signal, and transmits the external driving signal to the remote wakeup circuit 26.

The Ethernet port 25 receives the specific network packet, such as WoL, from an external twist line 23 in order to wake up the USB device 22.

The remote wakeup circuit 26 generates a wakeup signal to wake up the USB host 20 through the wakeup mask circuit 30 and the USB ports 211 and 212.

In operation, the Ethernet port 25 receives the data packet transmitted by the twist line 23. In response to a specific network packet, such as WoL, the Ethernet port 25 transmits a first signal to the remote wakeup circuit 26. In response to the first signal from the Ethernet port 25, or in response to a second signal (i.e., the external driving signal) from the wakeup pin 28, the remote wakeup circuit 26 generates and sends a wakeup signal to the wakeup mask circuit 30. When the wakeup mask circuit 30 receives the wakeup signal transmitted by the remote wakeup circuit 26, the wakeup mask circuit 30 delays the transmission of the wakeup signal for a predetermined time interval before sends the same through the USB port 211, USB transmission line 24, USB port 212 to wake up the USB host 20.

The USB device 22 transmits information through the Ethernet port 25, and supports a power saving mode defined by a USB protocol. Furthermore, the USB device 22 is woken up by a specific network packet from the Ethernet port 25 or by the driving signal from the wakeup pin 28, and wakes up the USB host 20 via the USB ports 211 and 212. The wakeup mask circuit 30 is allowed to mask wakeup events during a predetermined time delay set by a user, by delaying the sending of the wakeup signal for the predetermined time interval, and is allowed to send wakeup signals without any delay as the predetermined time delay is over.

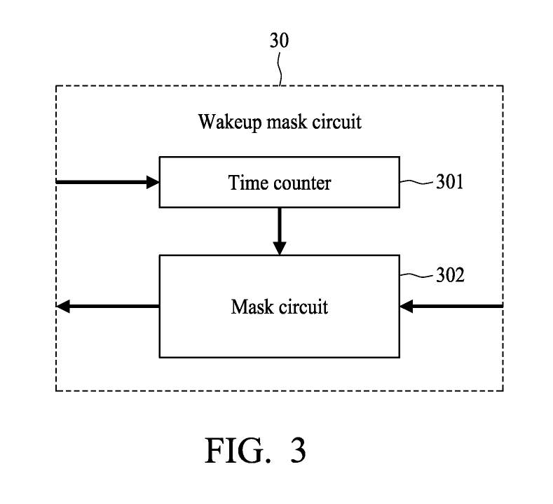

FIG. 3 shows a block diagram of the wakeup mask circuit 30 of FIG. 2. Referring to FIG. 3, the wakeup mask circuit 30 includes a time counter 301 and a mask circuit 302. The USB device 22 allows the user to set the value of the time counter 301 through the USB port 211, wherein the value of the time counter 301 is associated with a predetermined delay time, ranging from several seconds to several tens of seconds. In one embodiment of the present invention, the time counter 301 includes a countdown clock, and the mask circuit 302 includes a logic AND gate.

In operation, when the USB device 22 enters a suspend mode, the time counter 301 activates a time count to count to the predetermined delay time and generates a control signal for the mask circuit 302. The control signal exhibits a first state when the predetermined delay time is not reached, and exhibits a second state when the predetermined delay time is reached. The mask circuit 302, in response to the first state of the control signal, masks or blocks a wakeup signal from the remote wakeup circuit 26, and, in response to the second state of the control signal, i.e., as the time counter 301 counts to the predetermined delay time, allows the wakeup signal the remote wakeup circuit 26 to reach the USB host 20.

When the USB device 22 resumes from the suspend mode to a normal mode, the time counter 301 is reset to zero. The remote mask circuit 26 transmits the wakeup signal to wake up the USB host 20 through the USB ports 211 and 212.

Based on the embodiments of the present invention, the compatibility problem of the remote wakeup function can be resolved. If the USB device 22 enters a suspend mode earlier than the USB host 20, and if the USB device 22 is triggered to wake up by an external device while the USB host 20 is entering the suspend mode, then the USB host 20 and the USB device 22 operate in different modes, which may result in the compatibility issue. However, in USB specifications, no minimal remote wakeup time is defined. The present invention can resolve the problem that the USB device 22 fails to wake up the USB host 20, which may incur serious system error.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A Universal Serial Bus (“USB”) device with a remote wakeup function, comprising:
an Ethernet port, in response to a specific network packet, transmitting a first signal;
a wakeup pin, in response to a trigger signal, transmitting a second signal;
a remote wakeup circuit, in response to one of the first signal and the second signal, generating a wakeup signal; and
a wakeup mask circuit, configured to receive the wakeup signal, and does not allow transmission of the wakeup signal to a USB host until a predetermined delay time is over.

2. The USB device with a remote wakeup function of claim 1, wherein the wakeup mask circuit further comprises:
a time counter, in response to the USB device's entering a suspend mode, activating a time count and generating a control signal, wherein the control signal exhibits a first state when the predetermined delay time is not reached, and exhibits a second state when the predetermined delay time is reached.

3. The USB device with a remote wakeup function of claim 2, wherein the wakeup mask circuit further comprises:
a mask circuit, in response to the first state of the control signal, masking a wakeup signal from the remote wakeup circuit, and in response to the second state of the control signal, allowing the wakeup signal from the remote wakeup circuit to transmit to the USB host.

4. The USB device with a remote wakeup function of claim 1, wherein the specific network packet comprises a remote wakeup packet Wake-on-LAN (WoL).

5. The USB device with a remote wakeup function of claim 1, further comprising a USB port, wherein the wakeup mask circuit transmits the wakeup signal to the USB host through the USB port and a USB port connecting to the USB host.

6. The USB device with a remote wakeup function of claim 1, wherein the Ethernet port connects to a twist line to receive the specific network packet.

7. A USB device with a remote wakeup function, comprising:
a remote wakeup circuit, configured to generate a wakeup signal; and
a wakeup mask circuit, configured to receive the wakeup signal and delays transmission of the wakeup signal to a USB host for a predetermined delay time.

8. The USB device with a remote wakeup function of claim 7, further comprising:
an Ethernet port, in response to a specific network packet, transmitting a first signal; and
a wakeup pin, in response to a trigger signal, transmitting a second signal;
wherein the remote wakeup circuit, in response to one of the first signal and the second signal, generates the wakeup signal.

9. The USB device with a remote wakeup function of claim 7, wherein the wakeup mask circuit further comprises:
a time counter, in response to the USB device's entering a suspend mode, activating a time count and generating a control signal, wherein the control signal exhibits a first state when the predetermined delay time is not reached, and exhibits a second state when the predetermined delay time is reached.

10. The USB device with a remote wakeup function of claim 9, wherein the wakeup mask circuit further comprises:
a mask circuit, in response to the first state of the control signal, masking a wakeup signal from the remote wakeup circuit, and in response to the second state of the control signal, allowing the wakeup signal from the remote wakeup circuit to transmit to the USB host.
